(19) United States
(12) Patent Application Publication
(10) Pub. No.: US 2022/0280821 A1
(43) Pub. Date: Sep. 8, 2022

(54) Fire Control Enclosure

(71) Applicant: Srinivasa Rao Kanchadapu, Agoura Hills, CA (US)

(72) Inventor: Srinivasa Rao Kanchadapu, Agoura Hills, CA (US)

(21) Appl. No.: 17/194,242

(22) Filed: Mar. 6, 2021

(51) Int. Cl. A62C 3/02

(52) U.S. Cl. CPC A62C 3/0278

(57) ABSTRACT

A fire control enclosure with a telescoping rigid structural frame assembly, flame retardant fabric, a plurality of wheels and a plurality of smoke exhaust outlet pipes. The telescoping frame is capable of forming an elongate structure capable of controlling a fire that is set to create a fire break between two areas having ignitable material. Exhaust pipes are attached to the top of the structure to let smoke out. Metal wheels at the bottom of the structure allow it to be rolled into place. The fire control enclosure can alternatively be used to extinguish a fire with closed exhaust pipes.

### CROSS REFERENCE TO RELATED APPLICATIONS

Not Applicable.

### STATEMENT REGARDING FEDERALLY SPONSORED RESEARCH OR DEVELOPMENT

Not Applicable.

### DESCRIPTION OF ATTACHED APPENDIX

Not Applicable.

### BACKGROUND OF THE INVENTION

This invention relates generally to the field of fire suppression devices and more specifically to a fire control enclosure.

In an ongoing attempt to prevent wildfires from spreading, the idea of controlled burns has become popular. A controlled burn creates a section of ground where flammable materials have been eliminated so that a fire would have to jump over the bare ground to access adjacent burnable materials.

Such open burning conditions are problematic with presently available equipment and tools as even while practicing known safe control burn techniques, sizable risk of fire jumping over the controlled burn remains. Therefore, it would be helpful to have an easy to deploy fire resistant structure that could cover the control burn area preventing embers from flying to other areas having ignitable material.

### BRIEF SUMMARY OF THE INSTANT INVENTION

The primary object of the invention is to provide a novel fire control enclosure that allows fire professionals to safely create a fire break in foliage or other flammable material without risk of having the fire accidentally spread to other areas.

A further object of the invention is to provide a fire control enclosure that can be air lifted to fire locations.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a fire control enclosure comprising: a telescoping rigid structural frame assembly, flame retardant fabric, a plurality of wheels, a plurality of smoke exhaust outlet pipes, the telescoping rigid structural frame assembly that can be formed into an elongate structure comprising a plurality of frame members, thet frame members comprising a plurality of equally spaced vertical support poles and roof support joists, the telescoping frame members being horizontally disposed and forming the basis of the roof support joists, the side walls, a roof cover, end walls and a drag sheet constructed of the fire retardant fabric attached to the frame members to form an enclosed structure. The smoke exhaust outlet pipes being attached to the roof support joist and through apertures in the roof cover; the wheels being attached to the bottom end of the vertical support poles, and the telescoping rigid structural frame assembly and the flame retardant fabric capable of compressed for storage or expanded for use. The drag sheet capable of extending from the distal end of said enclosure to an area essentially equal to the length of the enclosure, enabling the drag sheet to cover the section of ground that has just been ignited, to ensure that any residual fire be eliminated and no embers can fly to out from the controlled burn area as the deployed fire enclosure is moved forward.

### BRIEF DESCRIPTION OF THE DRAWINGS

The drawings constitute a part of this specification and include exemplary embodiments of the instant invention, which may be embodied in various forms. It is to be understood that in some instances various aspects of the instant embodiments may be shown exaggerated or enlarged to facilitate an understanding of the instant embodiment.

FIG. 1 is a perspective view of the embodiment in the deployed position.

FIG. 2 is a perspective view of the interior of the fire-resistant structure.

FIG. 3 is a side view of the telescoping roof support pole in the deployed position.

FIG. 4 is a side view of a telescoping roof support pole in the stored position.

FIG. 5 is a perspective view of the embodiment in the compressed stored condition.

FIG. 6 is a perspective view of a blow torch nozzle inserted into the side wall.

FIG. 7 is a partial section view of an exhaust pipe.

FIG. 8 is a perspective view of the embodiment being loaded onto a flatbed truck.

FIG. 9 is a partial section view of a vehicle within the enclosure.

FIG. 10 is a perspective view of the enclosure bisecting a metal fence.

FIG. 11 is a perspective view of the enclosure being supported by a fleet of drones.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

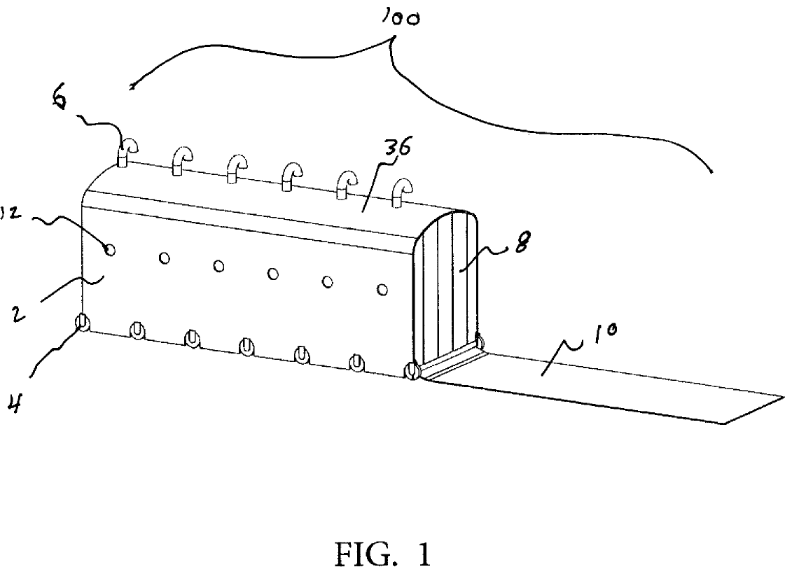

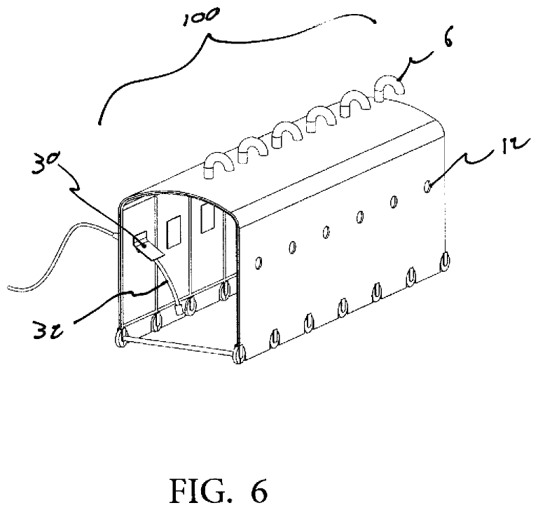

Referring now to FIG. 1 we see a perspective view of the embodiment 100. A fire-resistant cover 2, 36, 8 creates an enclosure that can be used to enclose controlled burns for fire safety concerns. Exhaust pipes 6 allow smoke to escape. Alternatively, the exhaust pipes may be closed, wherein the fire control enclosure then can be located over a fire, exhausting the oxygen within the fire control enclosure, therefore extinguishing the fire. Apertures 12 allow a person to insert the nozzle 32 of a blow torch to ignite a fire within the enclosure. The apertures are covered with a fire-resistant flap 30 which is attached at its top edge as shown in FIG. 6. Drag sheet 10 is attached to the distal end of the enclosure and is essentially a similar length to the enclosure so that when the enclosure is rolled forward on metal wheels 4, the recently burned area is covered by the drag sheet 10 to ensure that all fire in that area is extinguished. The fire-resistant cover is made of light weight material developed by NASA for extreme temperature conditions. It is called Beta Cloth. Beta cloth is a type of fireproof silica fiber cloth used in the manufacture of Apollo/Skylab A7L space suits, the Apollo Thermal Micrometeoroid Garment, the McDivitt Purse and in other specialized applications. Beta cloth consists of fine woven silica fiber, similar to fiberglass. The resulting fabric will not burn and will melt only at temperatures exceeding 650° C. (1,200° F.). To reduce its tendency to crease or tear when manipulated, and to increase durability, the fibers are coated with Teflon.

A tight weave of Beta cloth makes it more durable against atomic oxygen exposure. Its ability to resist atomic oxygen exposure makes it commonly used as the outer-most layer in multi-layer insulation for space, and it was used significantly on the Space Shuttle and the International Space Station. It was implemented in NASA space suits after the deadly 1967 Apollo 1 launch pad fire, in which the astronauts' nylon suits burned through. After the fire, NASA demanded any potentially flammable materials were to be removed from both the spacecraft and space suits. Beta cloth was developed by a Manned Spacecraft Center team led by Frederick S. Dawn and including Matthew I. Radnofsky working with the Owens-Corning and DuPont companies.

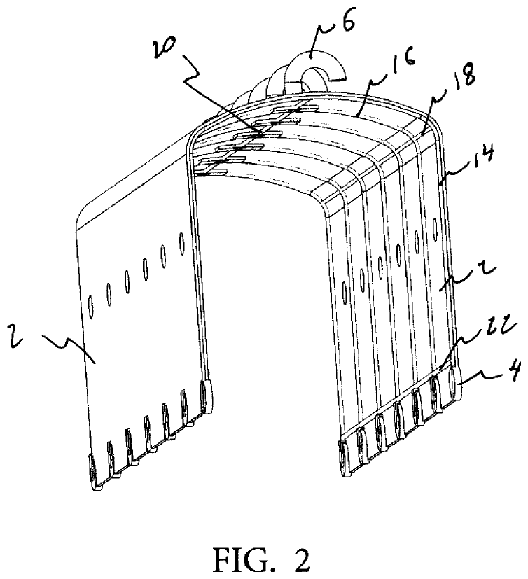

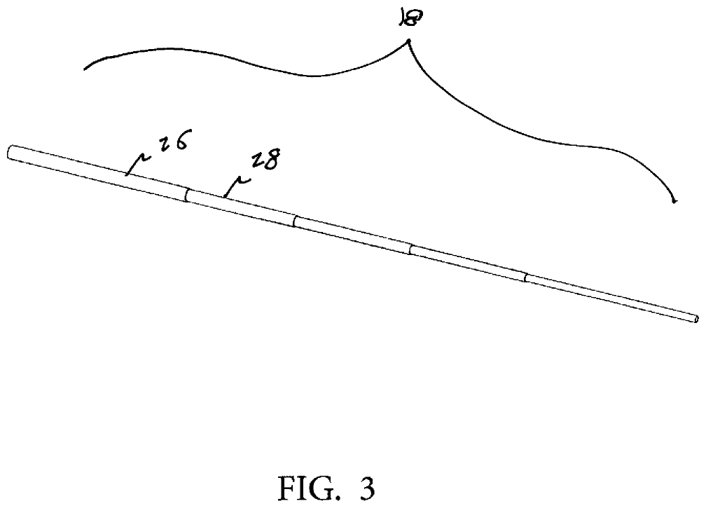

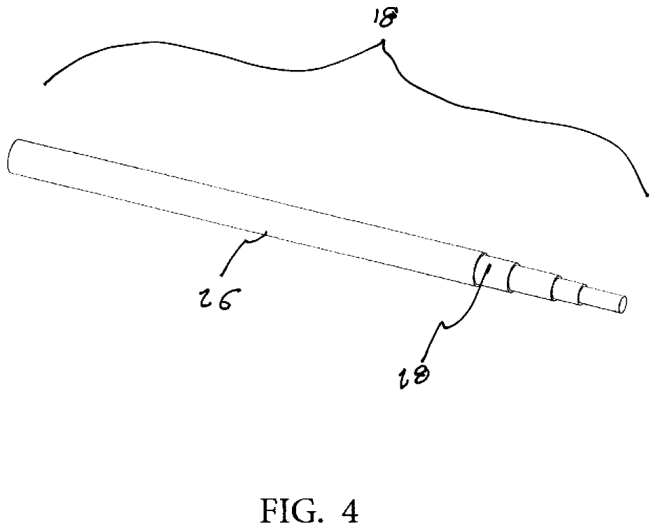

FIG. 2 is a perspective view of the interior of the enclosure with the front and rear panels and the drag sheet removed for clarity purposes. This view shows vertical support rods 14 as well as telescoping horizontal structural members 22, 18, 20 and the roof joist members 16. The telescoping principle is shown in FIG. 3 as fully extended use position and FIG. 4 as compressed to its storage position where smaller diameter tubes 28 can slide into or out of larger diameter tubes 26.

The tubes are made of light weight metal such as 6061 aluminum.

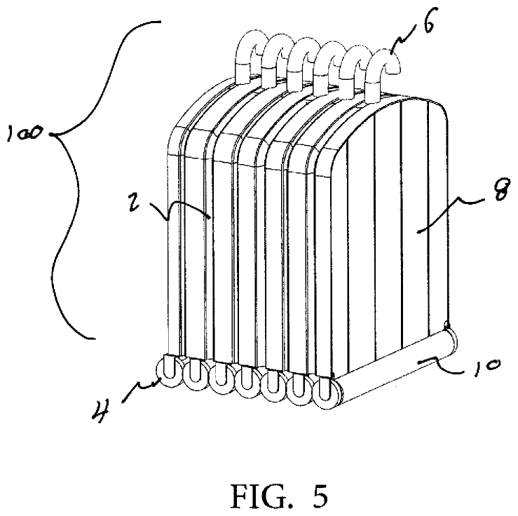

FIG. 5 is a perspective view of the embodiment 100 in the compressed, or stored position. All telescoping support tubes are compressed, and the flexible fire-resistant fabric 2 is folded accordion style to take up very little room. Drag sheet 10 is rolled up and stored. Wheels 4 are abutting each other and exhaust pipes 6 are also in close proximity to each other.

FIG. 6 is a perspective view of the embodiment 100 with the front cover 8 removed. Internal flaps 30 can be seen covering apertures 12. A user can insert the nozzle 32 of a blow torch to ignite a fire within the enclosure of the embodiment 100. The user can also temporarily push flap 30 aside to view conditions within the enclosure 100.

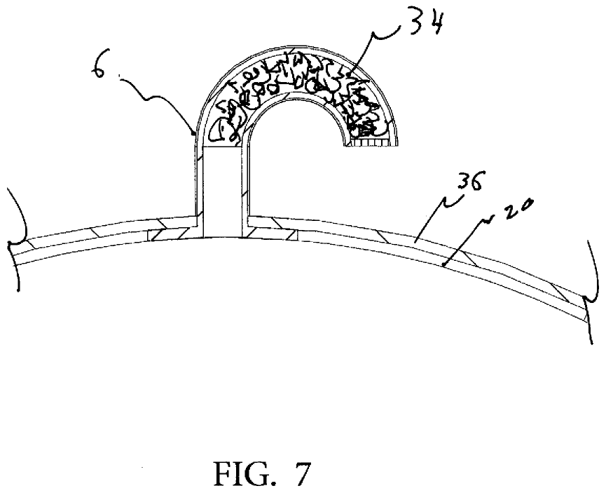

FIG. 7 is a partial section view showing exhaust pipe 6 having internal steel wool type baffling to ensure the collection of all embers as they try to escape the enclosure 100. The inverted J shape of the exhaust pipe 6 further reduces the chance of smoke and embers being blasted into the upper atmosphere.

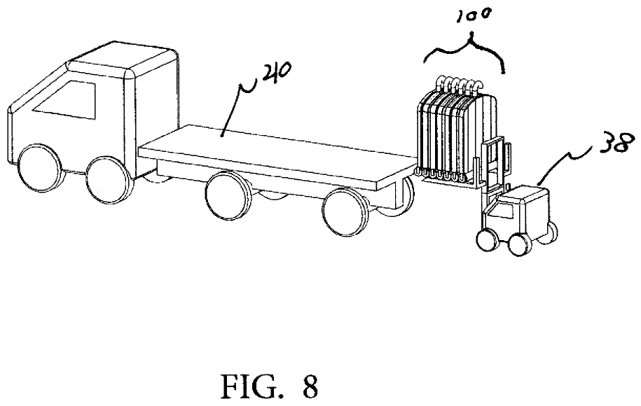

FIG. 8 is a perspective view of the embodiment 100 being loaded or removed from a flatbed truck. Its relatively light weight makes it easy to maneuver.

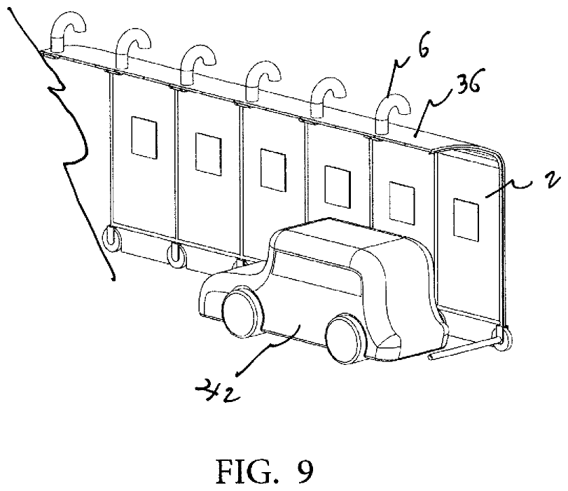

FIG. 9 is a perspective view of the embodiment 100 being used as an enclosure for a vehicle fire. A fire department can quickly deploy the embodiment to cover a burning vehicle and thereby contain any fire and also help eliminate the fire be reducing the amount of available oxygen allowed to surround the vehicle.

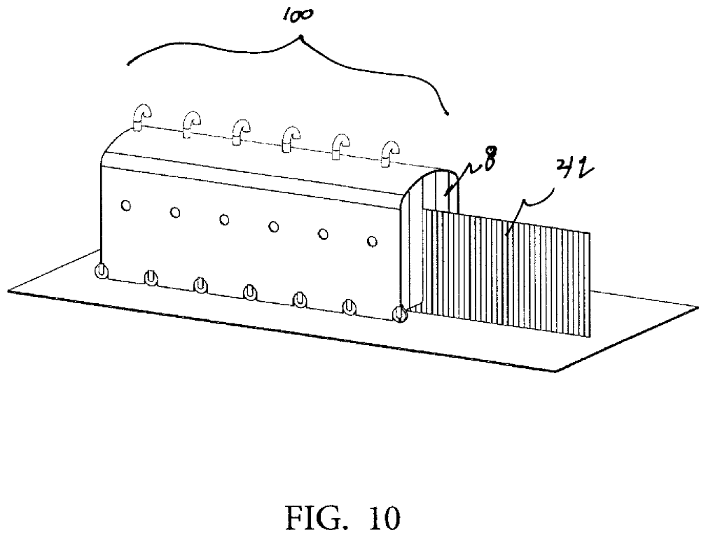

FIG. 10 is a perspective view of the embodiment 100 where the flaps of the front and back of the enclosure 100 allow the enclosure 100 to be rolled over the fence so that a control burn fire can be set on either side of the fence without danger of embers flying to surrounding areas.

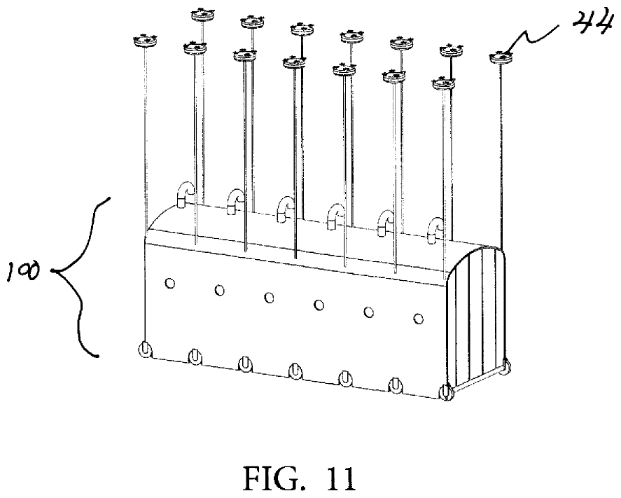

FIG. 11 is a perspective view of the embodiment 100 being lifted by a fleet of drones 44 so that it can be deployed and dropped in a controlled manor in a fire zone to help extinguish unwanted fires in remote locations.

While the invention has been described in connection with a preferred embodiment, it is not intended to limit the scope of the embodiment to the particular form set forth, but on the contrary, it is intended to cover such alternatives, modifications, and equivalents as may be included within the spirit and scope of the invention as defined by the appended claims.

In the claims, the word ‘comprising’ does not exclude the presence of other elements or steps then those listed in a claim. Furthermore, the terms “a” or “an,” as used herein, are defined as “one, or more than one.” Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are arbitrarily used to distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

As used throughout this application, the word “may” is used in a permissive sense (i.e., meaning having the potential to), rather than the mandatory sense (i.e., meaning must). Similarly, the words “include,” “including,” and “includes” mean “including, but not limited to” the listed item(s).

### Definitions

Proximal end and proximal surface being the end or the surface closer to the direction of moving the fire control enclosure in deployed state.

Distal end and distal surface being the end or the surface farther from the direction of moving the fire control enclosure in deployed state.

What is claimed is:

1. A fire control enclosure comprising:
a telescoping rigid structural frame assembly comprising telescoping frame members;
flame retardant fabric;
a plurality of wheels;
a plurality of smoke exhaust outlet pipes;
the telescoping rigid structural frame assembly capable of forming an elongate structure comprising a plurality of telescoping frame members;
the telescoping frame members comprising a plurality of equally spaced vertical support poles, wherein the vertical support poles include a bottom end and a top end, the top end being attached to the telescoping frame members, and roof support joists;
the telescoping frame members being horizontally disposed and forming a basis of the roof support joists;
side walls, a roof cover, end walls and a drag sheet constructed of the flame retardant fabric attached to the telescoping frame members to form an enclosed structure;
the smoke exhaust outlet pipes attached to the roof support joist and through apertures in the roof cover;
the wheels attached to the bottom end of the vertical support poles;
the telescoping rigid structural frame assembly and the flame retardant fabric capable of compressing for storage or expanding for use; and
the drag sheet extending from the distal end of the enclosure, wherein the drag sheet width and length are essentially same the width and length of the extended enclosure, enabling the drag sheet to cover a section of ground that has just been ignited with fire insuring that any residual fire be eliminated.

2. A fire control enclosure as claimed in claim 1 wherein the exhaust outlet pipes include steel wool filtering material within the exhaust outlet pipes to catch hot embers before they exit the enclosure.

3. A fire control enclosure as claimed in claim 1 wherein the side walls include ports to allow a user to insert a blow torch nozzle into the enclosure to ignite burnable materials within the enclosure;
the ports covered by the flame retardant fabric; and
the flame retardant fabric attached at its top edge allowing a user to move the fabric aside when needed and for the fabric to return to its original position when in use as a fire control enclosure.

4. A fire control enclosure as claimed in claim 1 wherein the enclosure can be rolled over a metal fence, wherein the metal fence bisects the space inside the fire control enclosure, allowing ignitable material on either side of the fence to be controllably burned.

5. A fire control enclosure as claimed in claim 1 wherein the fire control enclosure comprises heavy duty eyelets or similar devices capable of accepting lifting hooks;
the heavy duty eyelets or similar devices being attached to the telescoping frame members; and
the heavy duty eyelets or similar devices enable a fleet of drones or a helicopter to controllably drop the fire control enclosure on top of a burning fire, wherein the elimination of oxygen within the enclosure will extinguish the fire within the fire control enclosure.

6. A fire control enclosure as claimed in claim 1 wherein the fire control enclosure may be rolled to enclose a burning vehicle thereby containing the flames and extinguishing the fire by lack of oxygen.
